(19) United States
(12) Patent Application Publication
(10) Pub. No.: US 2009/0194043 A1
(43) Pub. Date: Aug. 6, 2009

(54) Engine

(76) Inventor: Jozef Goj, Colo Heights (AU)

Correspondence Address: JOEL D. SKINNER, JR.;SKINNER AND ASSOCIATES, 212 COMMERCIAL ST., HUDSON, WI, 54016, US

(21) Appl. No.: 12/309,499

(22) PCT Filed: Jul. 20, 2007
(86) PCT No.: PCT/AU2007/001015

§ 371 Date: Apr. 20, 2009

(30) Foreign Application Priority Data
Jul. 21, 2006 (AU) 2006903946

(51) Int. Cl. F02B 43/08; F04B 35/00

(52) U.S. Cl. 123/3; 417/364

(57) ABSTRACT

There is disclosed a hydrogen powered internal combustion engine (12) having cylinders (22) for driving crankshafts (28). The crankshafts are configured to drive water pumps (32) which are for pumping water into engagement with drive faces (58) of a drive water wheel (44). This water wheel is connected to, and drives, a main propulsion shaft (30) which produces the main propulsion of the engine, for example, for powering a vehicle. One or more ancillary water wheels (46, 48) are driven by the pumped water and are connected to generators for producing electric current for powering an electrolysis device (78) which produces hydrogen that can be used as fuel by the engine.

### FIELD OF THE INVENTION

This invention relates to an engine. More particularly, the invention relates to an engine which is in part a hydrogen internal combustion engine and in part a water wheel engine.

### BACKGROUND TO THE INVENTION

Hydrogen-fuelled internal combustion engines exist. Hydrogen is an environmentally friendly fuel, as the gases exhausted by the combustion process consist primarily of water vapour. However, one of the disadvantages of a hydrogen internal combustion engine, for example where it is used in a motor vehicle, is that a very large volume of the hydrogen gas needs to be stored to enable the vehicle to run for a distance sufficient to meet most practical requirements. On the other hand, the number of hydrogen refuelling stations, and the number of refuelling operations, that would be required to meet these practical requirements, would be extremely high, which would be both costly and inconvenient.

Another problem in relation to many existing internal combustion engines is that of engine vibrations. Typically, the pistons of such an engine are connected to a crank shaft which drives the vehicle. As the pistons do not all fire at the same time, there is an inherent unevenness of operation which contributes to such vibrations.

There are also situations where multiple engines are used, for example to increase overall power or to establish redundancy to provide for a situation in which one of the engines becomes incapacitated. If the two engines are used to drive a common output, such as a propulsion shaft, then there is an inherent problem of suitably synchronising the engines so that they do not cause undesirable stresses on the shaft. One manner of effecting such synchronisation is to use a liquid torque converter, but this typically suffers from power and heat losses.

It is an object of the present invention to overcome one or more of the disadvantages of the prior art or to provide an alternative.

### SUMMARY OF THE INVENTION

According to a first aspect of the invention there is provided an internal combustion engine including:
at least one combustion chamber having a power element configured for being driven by combustion that occurs in the chamber;
a crankshaft configured for being rotated by said driving of the power element;
a water pump connected to the crankshaft and configured for pumping water via a pump outlet on rotation of the crankshaft; and
at least one drive water wheel having a series of circumferentially spaced drive faces, the drive water wheel being disposed in relation to said pump outlet such that water pumped from said outlet will engage said drive faces for driving said drive water wheel in rotation.

In a preferred embodiment, the combustion chamber is a cylinder, and the power element is a piston configured for reciprocating motion in the cylinder, the piston being connected to the crankshaft whereby the crankshaft is caused to rotate by said reciprocating motion

In a preferred embodiment, the drive water wheel is mounted for rotation on a propulsion shaft the rotation of which constitutes a propulsion output of the engine.

In a preferred embodiment, the engine is configured for said combustion to be fuelled by hydrogen. Then, preferably, the engine includes at least one ancillary water wheel connected to a generator for generating electric current on rotation of the said ancillary water wheel. The current is preferably direct current (DC).

Preferably, the engine then also includes an electrolysis device in electrical connection with said generator and configured to be actuated by said current to effect electrolysis of water to form hydrogen and oxygen. Then, preferably, the engine includes at least one passageway configured to direct said formed hydrogen to said combustion chamber to serve as combustion fuel therein. Preferably, also, the engine includes at least one passageway configured to direct said formed oxygen to said combustion chamber to facilitate combustion of said hydrogen.

In a preferred embodiment, the engine includes a main water passageway for directing water pumped from said pump outlet into engagement with the drive faces of said at least one drive water wheel. Then, preferably, the at least one drive water wheel is positioned in relation to said main water passageway such that part of the drive water wheel protrudes into the main water passageway so that the drive faces of said wheel that are disposed on said part of the drive water wheel are positioned so as to be engaged by water travelling along the main water passageway.

Preferably, also, the at least one ancillary water wheel is positioned in relation to said main water passageway such that part of the drive water wheel protrudes into the main water passageway so that the drive faces of said wheel that are disposed on said part of the drive water wheel are positioned so as to be engaged by water travelling along the main water passageway.

In a preferred embodiment, the at least one drive water wheel has an axis of rotation and includes a first set of drive faces and at least one further set of drive faces, the drive faces of each set being disposed at a different radial distance from said axis of rotation to the drive faces of each other set, the engine being configured to selectively direct said pumped water to engage with the drive faces of any one of said sets, so as to achieve variable torque exerted on said drive wheel about said axis of rotation by said pumped water depending on the which of the sets of drive faces is engaged.

In a preferred embodiment, the engine includes a plurality of sub-passageways each in fluid-flow communication with said main water passageway, for selectively directing the water into engagement with the drive faces of the different respective sets of drive faces of the at least one drive water wheel.

Preferably, each sub-passageway is provided with a shut-off valve for preventing water from entering the sub-passageway from the main water passageway.

In one preferred embodiment, the engine includes a plurality of said drive water wheels. Also in a preferred embodiment, the engine includes a plurality of said ancillary water wheels.

In one preferred embodiment, the water wheels are arranged in a staggered formation in relation to one another. In another preferred embodiment, the engine includes a plurality of water wheels arranged in a substantially circular formation around a central drive water wheel.

In a preferred embodiment, the engine includes a plurality of said combustion chambers.

According to another aspect of the invention, there is provided a vehicle including an engine according the first aspect of the invention or any preferred embodiment thereof, the vehicle being at least one of: a motor-vehicle; a water-going vehicle; and an aircraft.

### BRIEF DESCRIPTION OF THE DRAWINGS

Preferred embodiments of the invention will now be described, by way of example only, with reference to the accompanying drawings in which:

FIG. 1 is a diagrammatic representation of part of an engine according to an embodiment of the invention;

FIG. 2 is a diagrammatic representation of an arrangement of drive wheels and water pipe of the engine of FIG. 1;

FIG. 3 is a cross-section of part of the arrangement of FIG. 2 along the lines III-III;

FIG. 4 is a diagrammatic representation of an alternative arrangement to that of FIG. 2;

FIG. 5 is a diagrammatic representation of a cylinder arrangement of an engine according to a different embodiment to that of FIG. 1;

FIG. 6 is a diagrammatic representation of yet another cylinder arrangement;

FIG. 7 is a schematic perspective view of an arrangement of banks of pistons and connecting rods;

FIG. 8 is a schematic perspective view of an undercarriage of a vehicle according to an embodiment of the invention;

FIG. 9 is a diagrammatic plan view showing the primary drive wheel of FIG. 2 according to an embodiment of the invention;

FIG. 10 is a diagrammatic representation, viewed from the side, of another arrangement of drive wheels and water pipe;

FIG. 11 is a diagrammatic view from above of the arrangement of FIG. 10;

FIG. 12 is a diagrammatic representation, viewed from above, of yet a further arrangement of drive wheels and water pipe; and

FIG. 13 is a diagrammatic representation, viewed from the side, of yet a further arrangement of drive wheels and water pipe.

### DETAILED DESCRIPTION

As described in more detail below, this invention relates to an engine, part of which, according to a preferred embodiment, operates as a hydrogen internal combustion engine. Preferably, the engine includes water pumps which are driven by hydrogen-fuelled pistons, and these pumps force water into engagement with drive wheels. The drive wheels thus constitute water-wheels. The drive wheels in turn provide the main drive torque of the engine, and also provide power for secondary uses, such as for generating electric current. This may be used for effecting electrolysis for creating hydrogen and oxygen gases, which can then be used for fuelling, and enhancing combustion, respectively, of the engine. Preferred embodiments of the invention are described below.

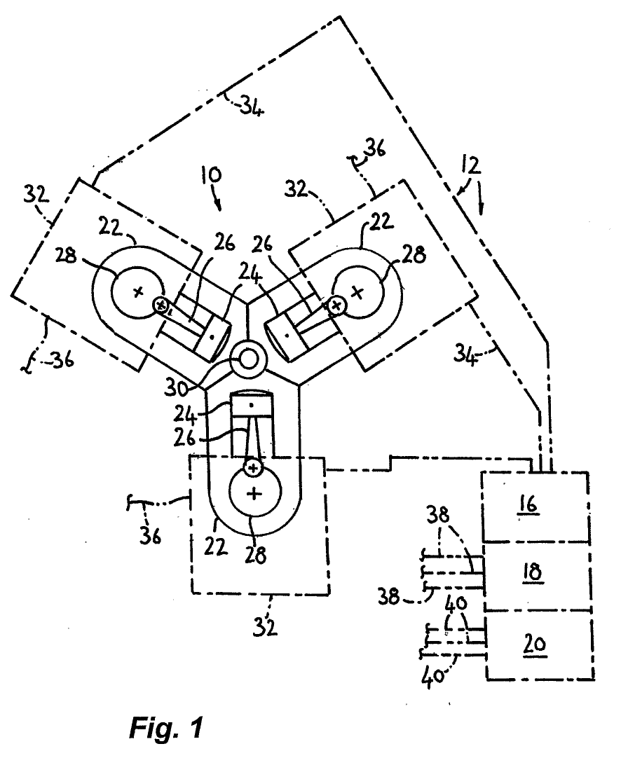

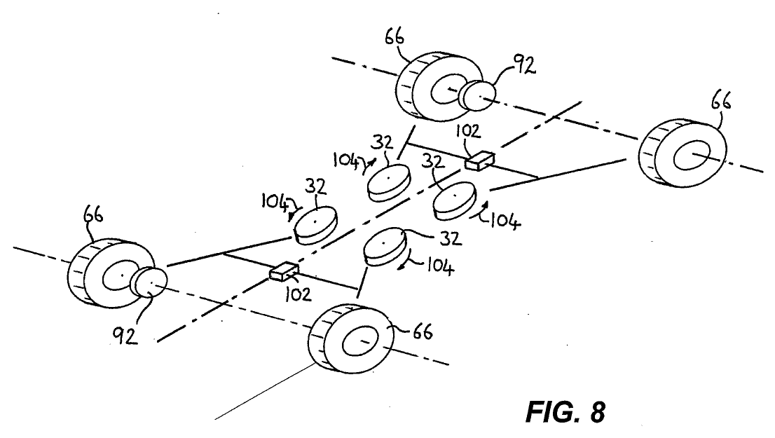

Referring to FIG. 1, there is shown an arrangement 10 of combustion chambers in the form of cylinders, according to an embodiment of the invention. The arrangement 10 constitutes part of the engine 12 of a motor vehicle 14 (part of which is shown in FIG. 8). As discussed in more detail below, the motor vehicle 14 is provided with a water tank 16, a hydrogen tank 18, and an oxygen tank 20.

In the arrangement 10, there are shown three cylinders 22 arranged in a “Y” configuration. In light of this arrangement, the cylinder block which incorporates the cylinders 22 may be regarded as a “Y-block.”

Each cylinder 22 includes a power element in the form of a piston 24 which is connected via a connecting rod 26 to a crank shaft 28. Unlike a conventional internal combustion engine in which the pistons are arranged to be connected via the connecting rods to a single crank shaft, in the present embodiment, there are three crankshafts 28, one for each cylinder 22, arranged towards the outer extremities of the cylinders.

In a preferred embodiment, the engine 12 is configured for the cylinders 22 to fire substantially simultaneously. As a result, as the pistons 24 are travelling to their top dead centre positions, they are all travelling towards each other, and as they are travelling to the bottom dead centre positions they are moving away from one another. Thus, the reaction forces caused by the moving of each piston 24 should be balanced and thus neutralised, by the moving of all of the pistons together. The ability of the pistons 24 to move simultaneously in this manner is created or at least facilitated by the use of the separate crankshaft 28.

The engine 12 employs a dry sump arrangement for lubricating oil, with take-ups (not shown) arranged for directing accumulated oil to storage tanks (not shown) located at one or more suitable positions depending on the embodiment. Thus, depending on the position of the take-ups in the particular form of the present embodiment, the engine 12 may be operated at different angles to the horizontal.

In one preferred embodiment, the cylinders 22 and pistons 24 are made using high temperature ceramics.

Disposed centrally relative to the cylinders 22 is a main propulsion shaft 30. Inlet and exhaust valves (not shown) of each cylinder 22 are disposed adjacent to the respective piston 24, that is, in proximity to the main propulsion shaft 30.

Each crank shaft 28 is connected to a respective high pressure water pump 32 (details of which are not shown), and serves as the input drive of the pump.

Each pump 32 is provided with a water inlet 34 and a water outlet 36, and is driven by rotation of the particular crank shaft 28 that is connected to the pump. Each inlet 34 is configured to receive a supply of water into the pump 32 from the water tank 16, and the outlet 36 is configured to direct the pumped water from the pump under high pressure. In one preferred embodiment, reduction nozzles (not shown) are provided upstream or downstream of the outlet 36 for producing jets of flowing water, and for increasing flow velocity of the water and regulating the water pressure.

Preferably, each pump 32 is capable of pumping water at a relatively high pressure across a broad range of revolution speeds of the input drive of the pump (i.e. of the relevant crankshaft 28).

The engine 12 is in part a hydrogen internal combustion engine, which is fuelled by hydrogen gas. The hydrogen gas may be provided from the hydrogen tank 18, in which the hydrogen is stored in compressed, liquid form. The hydrogen gas is supplied to the cylinders 22 via hydrogen delivery conduits 38.

Also supplied to the cylinders 22, together with the hydrogen gas, is oxygen gas which is stored, also in compressed, liquid form, in the oxygen tank 20. The oxygen gas is for enhancing the combustion of the hydrogen. The oxygen gas is supplied to the cylinders via oxygen delivery conduits 40.

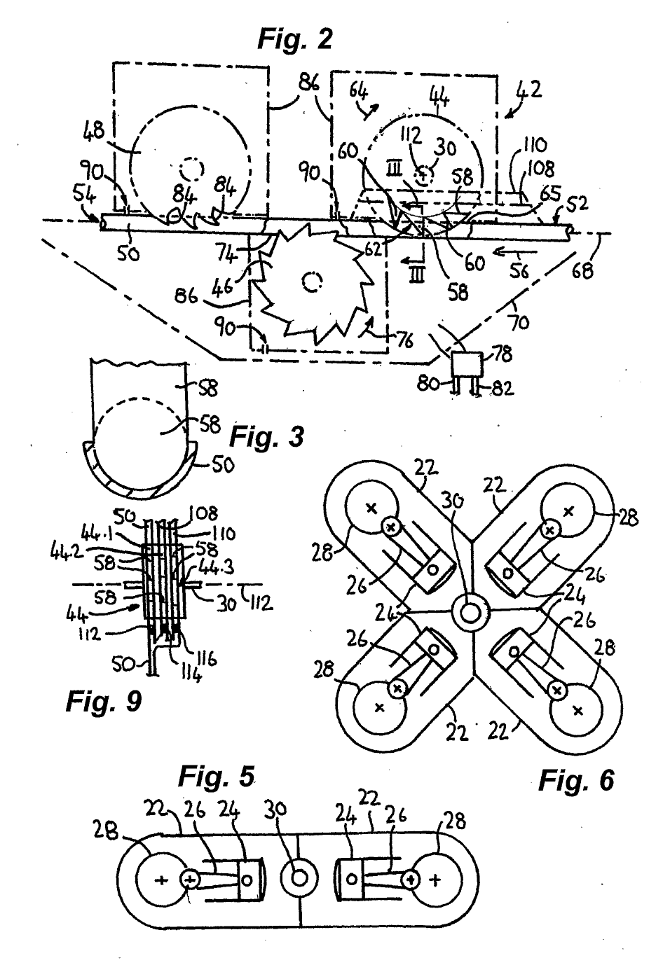

Referring to FIG. 2, there is shown an arrangement 42 of drive wheels, being a primary, power drive water wheel 44, an ancillary, secondary drive water wheel 46 and an ancillary third drive water wheel 48. The third drive wheel 48, and part of the primary drive wheel 44 are shown in phantom lines.

Each drive wheel 44, 46, 48 is of sufficient weight that it serves as a flywheel.

The arrangement 42 includes a main water passageway in the form of a water supply pipe 50 which is connected to the outlet 36 of one of the pumps 32. Thus water pumped by that pump is forced along the pipe 50 via the right hand extremity 52 of the pipe as shown in FIG. 2, towards the left hand extremity 54 as shown, that is, in the direction of the arrow 56. The water pipe 50 leads in the direction 56 from the relevant pump 32 and then back to the water tank 20.

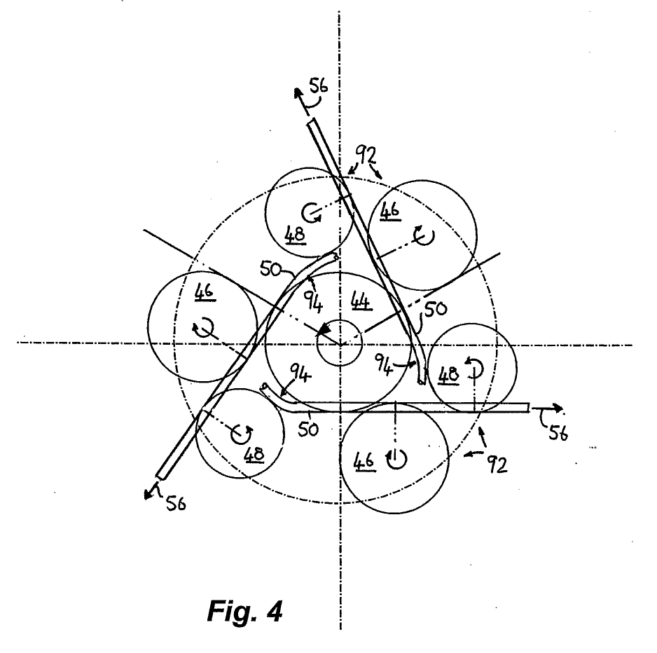

Similar arrangements (not shown) to the arrangement 42 shown in FIG. 2 are provided in relation to the other two pumps 32 shown in FIG. 1, with their respective water pipes 50 being connected to the outlets 36 of those pumps. In a preferred embodiment, the three arrangements relating to the three pumps 32 share a common primary drive wheel 44, as discussed further with reference to FIG. 4.

In the arrangement 42, the primary drive wheel 44 includes a number of drive faces 58 (only some of which are shown) which are spaced around the outer circumference of the drive wheel and which are supported by side walls 60. The configuration of the drive faces 58 and side walls 60 is such that the primary drive wheel 44 has a circumferential “saw-tooth” appearance. As a result, the profile formed by each pair of successive drive faces 58 and the intermediate side wall 60 is roughly of a “Z” shape. The arrangement 42 of FIG. 2 may thus be referred to as a “Z-drive” arrangement.

A portion 62 of the primary drive wheel 44 protrudes into the pipe 50 via a slot 65 running along the upper side of the pipe as viewed in FIG. 2. The slot 65 may be so broad as to effectively take the place of the upper half of the pipe 50.

As pumped water travels along the pipe 50 in the direction of the arrow 56, the water impacts on the drive faces 58 of the portion 62 of the primary drive wheel 44 protruding into the pipe, and causes the primary drive wheel to rotate in the direction of the arrow 64.

The primary drive 44 wheel is connected to the main propulsion shaft 30 which, in turn, may be connected directly, or via a gearbox or torque converter (not shown), to one or more of the road wheels 66 of the vehicle 14 (see FIG. 8) to drive the vehicle.

The primary drive wheel 44, being the first of the drive. wheels 44, 46 and 48 to be impacted by the water travelling along the pipe 50, effectively has the full potential drive force of the water available to it.

The drive faces 58 are of a width corresponding substantially to the inner diameter of the pipe 50, and their extremities are shaped to conform to the inner diameter of the pipe. Thus, as shown in FIG. 3, those drive faces 58 forming part of the particular portion 62 of the primary drive wheel 44 that protrudes into the pipe 50 at any one time effectively extend across the entire area bound by the circumference of the pipe. As a result, the water travelling along the pipe 50 effectively cannot bypass the drive face 58 if the drive face is protruding to the maximum extent into the pipe as shown. Consequently, the full impact of the water is experienced by that drive face 58 so that the maximum effective force can be exerted at that location on the drive face.

The fact that the water is effectively trapped within the pipe 50 and between the pipe and the drive wheel 44 means that dissipation of the force of the water that might result due to lateral deflection of the water is minimised.

The drive faces 58 of the drive wheel 44 are substantially flat and substantially perpendicular to the axis 68 of the pipe 50. When a particular drive face 58 is at the maximum protrusion into the pipe 50, it is therefore perpendicular to the flow direction 56 of the water.

When the primary drive wheel 44 continues to rotate in the direction 64 and a particular drive face 58 begins to move out of the pipe 50 through the slot 65, the surface area of that drive face extending through the slot decreases, and the angle of the drive face becomes closer to being parallel with the axis 68 of the pipe. This, together with the flat configuration of the drive face 58, allows the water to easily run off, and bypass, the drive face and continue along the pipe 50.

The orientation of the water flow perpendicular to the drive faces 58 when they protrude to the maximum extent into the pipe 50 also means that the water is flowing substantially tangentially relative to the primary drive wheel 44. This assists in providing a greater rotational force on the primary drive wheel 44 than would have been the case had the angle of the water been other than tangential.

The primary drive wheel 44 is configured so that large portions of the side walls 60 are immediately adjacent to the inner edges of the slot 65. This results in the primary drive wheel 44 preventing most of the water in the pipe 50 from leaking out of the pipe through the slot 65. However, any water from the pipe 50 that does escape the pipe is allowed to fall into a collection tank 70 in which the pipe is disposed. This water is referred to further, below.

The water that continues along the pipe 50 downstream of the primary drive wheel 44, including that water that engaged one or more drive faces 58 of the primary drive wheel, can now engage drive faces 72 of the secondary drive wheel 46 in a similar manner. As mentioned above, the secondary drive wheel 46 is of a similar construction to the primary drive wheel 44, and has a similar relationship to the pipe 50, which is provided with a further slot 74 for the secondary drive wheel to protrude into the pipe.

The water downstream of the primary drive wheel 44 that engages the drive faces 72 of the secondary drive wheel 46 causes that wheel to be rotated in the direction of the arrow 76, in a similar manner to that in which the primary drive wheel 44 was rotated as indicated by the arrow 64.

However, due to the obstructing effect of the primary drive wheel 44, at least part of the driving force of the water travelling along the pipe 50 may have been dissipated by the time that this water engages the secondary drive wheel 46. This is not problematic as the secondary drive wheel 46 is not configured for driving a main drive shaft of the vehicle 14 as was the case with the primary drive wheel 44 in relation to the propulsion shaft 30. The secondary drive wheel 46 is used to drive a generator or dynamo (not shown) for generating DC electric current.

Due to the fact that the secondary drive wheel 46 is downstream of the primary drive. wheel 44 in relation to the pipe 50, the effect that the water has on the primary drive wheel is substantially unaffected by the presence of the secondary drive wheel, or even the third drive wheel 48.

The electric current produced by the above-mentioned generator is in turn used for an electrolysis device 78 connected to the generator. The electrolysis device 78 is configured to effect electrolysis on water that is directed to the device from the water tank 16 along suitable channels (not shown). Thus, it can produce hydrogen and oxygen gas from the water by passing a current between a suitable cathode and anode (not shown) forming part of the electrolysis device. The hydrogen formed by the electrolysis device 78 is then directed back along suitable hydrogen return passageways in the form of channels 80 towards the cylinders 22 where it is introduced into the cylinders as fuel.

Similarly the oxygen formed by the electrolysis device 78 is also directed back to the cylinders 22 along passageways in the form of oxygen return channels 82, where it is introduced, to enhance the combustion of the hydrogen. Indeed, providing substantially pure oxygen gas to the combustion process should facilitate this process to a greater extent than providing air.

Part of the electric current produced by the above-mentioned generator can be used to power suitable pumps (not shown) for pumping the hydrogen and oxygen gases towards the cylinders 22. Depending on the particular embodiment, if the pressures induced on these gases by the pumps are sufficient to cause the gases to change phase into liquid form, then to control the temperature of the liquid, suitable cooling or refrigeration units (not shown) may also be provided. These may also be powered by current produced by the generator. In addition, if the gases are indeed converted to liquid form, then as an alternative to their being introduced to the cylinders 22, they may be directed, instead, to the hydrogen and oxygen tanks 18 and 20.

In one preferred embodiment, the engine 12 is configured such that, if such hydrogen from the electrolysis device 78 is available for directing to the cylinders 22, this hydrogen rather than that from the hydrogen storage tank 18 will be used. One manner of effecting this is to switch off the hydrogen pump (not shown) which is provided for pumping hydrogen from the hydrogen storage tanks 18, when hydrogen from the electrolysis process is available. A suitable control (not shown) using a flow meter may be provided to ensure that the delivery of the gas from the electrolysis device 78 is at the same speed as that from the hydrogen storage tank 18.

As in the case of the primary drive wheel 44, as the secondary drive wheel 46 rotates, due to the flat shape of the drive faces 72, the water driving the secondary drive wheel can easily run off and bypass these faces and continue 15. along the pipe 50 in the flow direction 56 towards the third drive wheel 48.

The third drive wheel 48 is essentially the same as the primary and secondary drive wheels 44 and 46 and has a similar relationship to the pipe 50, except that it has drive faces 84 which are not substantially flat, but are concave or scooped so that the third drive wheel is essentially in the form of a Pelton wheel. Thus, much of the water that impacts on the drive faces 84 of the third drive wheel 48 cannot easily run off the drive faces 84 but, rather, is caught by these faces. This assists in imparting a greater proportion of the momentum of the water travelling along the pipe 50 to the third drive wheel 48 than would have been the case had the drive faces 58 of the third drive wheel been flat as are those of the primary and secondary drive faces 58 and 72. This also assists in dissipating the force of the water so that this force is largely spent after the water engages the third drive wheel 48.

In the same manner that the primary and secondary drive wheels 44 and 46 extend through slots 65 and 74 to protrude into the pipe 50, the third drive wheel 48 protrudes into the pipe through another slot 88 therein.

The third drive wheel 48 is also used for driving a generator or dynamo (not shown) to create DC current for actuating the electrolysis device 78 or a further electrolysis device (not shown).

That water that passes the third drive wheel 48, and the left hand extremity 54 of the pipe 50 as shown in FIG. 2, is returned to the water storage tank 16.

In one preferred embodiment, the drive wheels 44, 46 and 48 are located in air chambers 86 above the collection tank 70. As a result of being disposed in air, there is less resistance to rotation of the drive wheels 44, 46 and 48 than there would have been had they been disposed, for example, in water.

Part of the water leaking from the pipe 50 via the slots 65, 74 and 88 and water from the pipe 50 that is carried out of the pipe as the drive wheels 44, 46 and 48 rotate, is caught in the collection tank 70 and part in the air chambers 86. The chambers 86 are therefore provided with drain holes 90 to allow the water to be drained into the collection tank 70. From the collection tank 70 it is pumped back to the water storage tank 16.

In FIG. 4, there is shown an alternative embodiment to the arrangement 42 shown in FIG. 2. The embodiment of FIG. 4 includes three drive-wheel/water-pipe arrangements 92, although they share a common primary drive wheel 44.

Each of the arrangements 92 shown in this embodiment, apart from the shared, common primary drive wheel 44, also includes a secondary drive wheel 46 and a three third drive wheel 48. As can be seen, the water pipes 50 in this embodiment are orientated to direct the water flowing therein so that it curves, at the positions 94, around the primary drive wheel 44. This configuration may be used to conserve space.

There are many different possible embodiments of the engine 12, with alternative different configurations of the various components.

For example, with reference to FIG. 5, instead of having three cylinders arranged in a “Y” configuration, there are only two cylinders 22 arranged in a directly opposing configuration.

The embodiment of FIG. 6 has four cylinders 22 arranged in an “X” formation. In light of this arrangement, the cylinder block which incorporates the cylinders 22 may be regarded as an “X-block.”

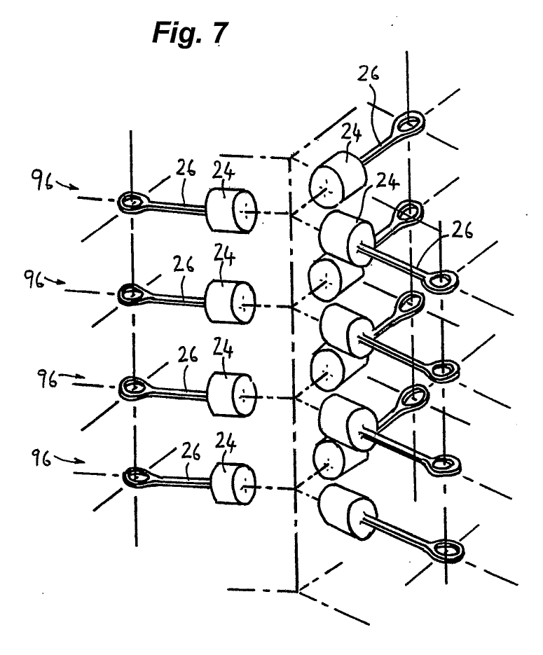

In other embodiments, there may be multiple banks of the cylinder arrangements shown in FIG. 1, 5 or 6. Thus, in FIG. 7 there are shown pistons 24 and connecting rods 26 of four banks 96 of cylinders 22 (the cylinders themselves not being shown) of the “Y” configuration of FIG. 1. Thus there are a total of twelve cylinders.

In other embodiments, there may be two banks with six cylinders 22, three banks with nine cylinders, and so on.

As a further alternative, there may be a different number of cylinders 22 for each bank. However, in preferred embodiments, such cylinders 22 are positioned to be evenly spaced in their circular configuration so as to assist in achieving a neutralising of the unbalancing reaction forces caused by the motion of the pistons 24, and hence of neutralising vibrations.

Just as there may be multiple banks of cylinders, there may also be multiple drive-wheel/water-pipe arrangements.

Thus, for example, where there are multiple banks of cylinder arrangements such as the banks 96 shown in FIG. 7, there may a separate respective drive wheel arrangement, such as the arrangement 42 in FIG. 2, for each bank of cylinders.

It will be appreciated that the number of drive-wheel/water-pipe arrangements may depend on the number of cylinders 22 used in the engine 12. The arrangements preferably share a common primary drive wheel 44 as in the embodiment shown in FIG. 4.

As another alternative, there may be more than one drive wheel 44 in a set of drive-wheel/water-pipe arrangements. For example, in one embodiment (not shown) there may be four banks of cylinders, each bank being, for instance of the “X” configuration of FIG. 6. In this embodiment, each bank may have a respective drive-wheel/water-pipe arrangement, for instance in the form of the arrangement 42 of FIG. 2. In this case, as there are four such wheel/water-pipe arrangements altogether, there may be two primary drive wheels 44, one being shared by a first pair of the arrangements, and the other being shared by the other pair of the arrangements.

In one form of this embodiment, the two primary drive wheels 44 are disposed on a single propulsion shaft, while in another form, they are disposed on separate propulsion shafts.

While the primary drive wheel 44, and hence the propulsion shaft 30 on which it is mounted, is shown centrally positioned in relation to the cylinders 22 in the embodiments of FIGS. 1, 5 and 6, in another embodiment (not shown) the primary drive wheel is disposed at a different location in relation to the cylinders. However, other aspects of the drive-wheel/water-pipe arrangement in this embodiment may be the same as in the other embodiments described. Indeed, the position of the drive-wheel/water-pipe arrangement (and hence the primary drive wheel 44 and shaft 30 on which it is mounted) need not be dependent on the position or orientation of the cylinders 22, provided the water from the water pumps 32 is suitably directed to the drive wheels.

As mentioned above, in FIG. 8, there is shown part of the motor vehicle 14. The vehicle 14 includes four drive-wheel/water-pipe arrangements 92 (only two of which are shown, not in detail), immediately adjacent to the vehicle road wheels 66. The central drive wheel of each of these arrangements 42 is a primary drive wheel 44, which is directly joined to the adjacent road wheel 66.

In this embodiment, computer controllers 102 are provided for regulating the supply of water from the pumps 32 to the drive wheel arrangements 42, and hence to the primary drive wheels 44. Thus, the power supplied to each primary drive wheel 44, and hence to the road wheel 66 to which it is connected, can be regulated to achieve an even supply of power among the road wheels.

In one preferred form of this embodiment, the cylinders 22 are arranged in the “X” configuration of FIG. 6, with one water pump 32 per cylinder 22 (only the pumps 32 being shown). The four water pumps 32 are orientated so that there are two pumps. rotating in a clockwise direction when viewed from above, and two rotating in an anti-clockwise direction, as indicated by the arrows 104. This assists in enhancing the balance of the vehicle 14.

In one preferred embodiment, the hydrogen delivery conduits 38 joined to the hydrogen storage tanks 18 are channelled through passages in the engine block (not shown) of the engine 12. This enables part of the accumulated heat of the engine block to be transferred to the hydrogen travelling along these passages. This not only assists in causing the hydrogen to change phase from liquid into gas for use as fuel in the cylinders 22, but also assists in cooling the engine 12.

Where such passages are not provided, or as an alternative to their use for cooling (depending on the particular embodiment), conventional engine water- or air-cooling may be used.

Indeed, part of the power generated by the rotation of the secondary or third drive wheels 46 and 48 as described above may be used as a source of power for controlling temperature of the hydrogen storage tank 18. This can be achieved by suitable cooling or refrigeration units (not shown) which use such power generated by the rotation of the secondary or third drive wheels 46 and 48 to operate.

In use, the engine 12 is used to drive the vehicle 14. Whatever the particular arrangement of drive wheels and water pipes, in each case the hydrogen fuelled cylinders 22 drive the water pumps 32, which establish jets of water that travel along the water pipes 50. This water then drives the primary drive wheels 44, the secondary drive wheels 46 and the third drive wheels 48 (although in certain embodiments the third drive wheel can be omitted). The rotation of the primary drive wheels 44 causes the propulsion shafts 30 on which they are mounted to rotate thereby propelling the vehicle, either by way of direct connection of the propulsion shafts to the road wheels 66 as shown in FIG. 8 or by way of connection via a gearbox or torque converter (not shown).

The secondary drive wheel 46 (and third drive wheel 48 where provided) drives the electrolysis device 78 using Water supplied from the water tank 16 to create hydrogen and oxygen. The hydrogen produced in this manner is then directed to the cylinders 22 where it is used as the fuel while the oxygen produced in this manner is also directed to the cylinders 22 where it is used to facilitate the combustion of the hydrogen fuel.

As mentioned above, the drive wheels 44, 46 and 48 are sufficiently heavy to constitute flywheels. It will be appreciated that to initiate rotational movement of a heavy drive wheel, a relatively high torque is needed. The arrangement 42 illustrated in FIG. 2 is suitable for this purpose as the water pipe 50, and hence driving force of the water travelling along this pipe, is located at the circumference of the drive wheels. However, once the drive wheels are in motion, less torque is required, and the water may be used instead for maintaining a relatively high rotational speed of the drive wheels.

To achieve this, the water needs to drive the wheels 44, 46 and 48 at a position closer to their axes of rotation. In order to divert the water to a position closer to the axes of rotation, pipe branches 108 and 110 may be provided as shown in the embodiment of FIG. 9 (shown as phantom lines in FIG. 2). These pipe branches 108 and 110 are shown in relation to a primary drive wheel 44.

The pipe branch 108 is positioned to intersect the drive faces 58 of the primary drive wheel 44 at a position closer to axis of rotation 112 of the wheel, and the pipe branch 110 is positioned to intersect the drive faces at a position even closer to axis. This is best seen in FIG. 2.

It will be appreciated, however, that to achieve this configuration, it is necessary to have three annular arrangements 44.1, 44.2 and 44.3 of drive faces 58, these arrangements being spaced apart from one another along the axis. This is so that one of these arrangements 44.1 can protrude into the water pipe 50, the next arrangement 44.2 into the branch pipe 108 and the third arrangement 44.3 into the branch pipe 110.

The diverting of water from the water pipe 50 into the branch pipe 108, or alternatively into the branch pipe 110, is controlled by operation of suitable shut-off valves 112, 114 and 116. Thus, for example, once the primary drive wheel 44 has reached a sufficient rotational speed, when a smaller accelerating torque is required to be exerted on the wheel, the valve 112 can be closed and the valve 114 opened so that the water is diverted to pass along the branch pipe 108 before rejoining downstream of the wheel with the water pipe 50. The water passing along the branch pipe 108 engages the drive faces 58 at a position closer to the axis 112 and thus exerts a lower torque on the primary drive wheel. Thus, the rate of acceleration of the primary drive wheel 44 in rotation is decreased, although the water is capable of maintaining the wheel at a higher rotational speed.

After further acceleration of the primary drive wheel 44 has occurred (albeit at a lower rate of acceleration), it will be appreciated that the rotational speed of the wheel will have increased even further. Once the speed has reached the maximum desired operational speed, the shut-off valve 114 can be closed and the valve 116 opened. This causes the water flow to be diverted from the branch pipe 108 to the branch pipe 110 before it rejoins with the water pipe 50, downstream of the wheel. This pipe 110 directs the water to engage the drive faces 58 which are even closer to the axis of rotation 112 of the primary drive wheel 44. Thus, this water exerts an even lower torque on the primary drive wheel 44 than that exerted by the water flowing in the branch pipe 108. This lower torque may be only sufficient to accelerate the primary drive wheel 44 in rotation to a limited extent, but the force exerted by this water may be sufficient to maintain the primary drive wheel at its already increased rotational speed.

Should the rotational speed of the primary drive wheel 44 decrease, for example in order to slow the vehicle down, the valve 116 can be closed and the valve 112 opened again so that the water once again flows only along the water pipe 50 and not along either of the branch pipes 108 or 110.

One advantage of preferred embodiments of the invention is that, as described above, the engine 14 lends itself to the use of a separate crankshaft for each cylinder. This, in turn, allows the pistons to operate simultaneously as far as piston position is concerned. Accordingly, provided the pistons are orientated so as to be evenly spaced in a circular configuration, or symmetrically, in relation to one another, the unbalancing forces of any piston are effectively neutralised by similar forces of the other pistons operating together. The fact that the engine lends itself to having a separate crankshaft for each cylinder, in turn, is enabled by having the water wheel arrangement as described. This enables the driving forces of the separate crank shafts to be “converted” to a single output at the primary drive wheel.

Another advantage is that the output of the engine is itself used to generate electricity which is used to effect electrolysis, which produces hydrogen which is used as the engine's fuel. Thus the operation of the engine itself contributes to a fuelling of the engine.

As mentioned above, the weight of the drive wheels is such that they constitute flywheels. In addition, when spinning, each exhibits the gyroscopic effect. The combined gyroscopic effect of the drive wheels spinning simultaneously may assist in stabilising the engine, and hence a vehicle in which the engine is mounted.

Although the invention is described above with reference to specific embodiments, it will be appreciated by those skilled in the art that it is not limited to those embodiments, but may be embodied in many other forms.

In one further embodiment, the motor vehicle 14 includes a water refilling inlet (not shown) for adding water to the water tank 16. In addition, the motor vehicle 14 includes a water filter (also not shown) for filtering water added to the water tank 16 via the refilling inlet. The water filter is suitable for filtering water sufficiently to render it of a drinkable (portable) quality. This is important due to the close tolerances and high water pressure attributes of preferred embodiments of the engine 12, as contaminants that are filtered out might otherwise have a fouling effect and compromise the operation of the engine.

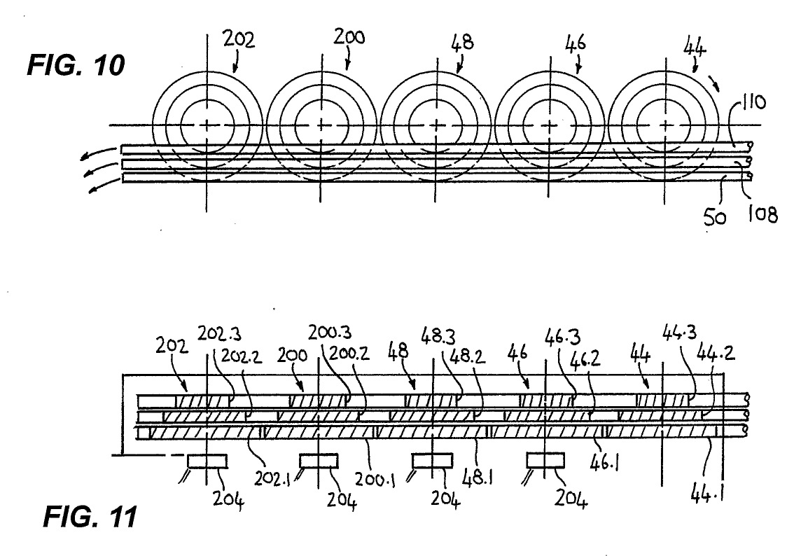

With reference to FIGS. 10 and 11, there is shown a further embodiment to that shown in FIGS. 2 and 4, of an arrangement of drive wheels and water pipe. Components in these figures corresponding to components in FIG. 2 have similar reference numerals.

In addition to the primary, secondary and third drive wheels 44, 46 and 48, there are two additional drive wheels, being a fourth drive wheel 200 and a fifth drive wheel 202. These drive wheels 200, 202 perform a similar function to the secondary and third drive wheels 46 and 48, that is, to generate DC current.

The drive wheels in this embodiment are arranged in a substantially straight line.

In this embodiment, each of the drive wheels, as opposed to just the primary drive wheel 44, is provided with three annular arrangements of drive faces. For each of the drive wheels, the three arrangements of drive faces are indicated with reference numerals corresponding to the reference numeral of the respective wheel but with the addition of a suffix. This is the suffix “.1” for the annular arrangement with the greatest diameter, the suffix “.2” for the annular arrangement with the second largest diameter, and the suffix “.3” for the annular arrangement with the smallest diameter.

Because each of the drive wheels in this embodiment has three annular arrangements of drive faces, the pipe branches 108 and 110 continue for a length that traverses all of the drive wheels before the pipe branches rejoin with the water pipe 50.

In this embodiment the third drive wheel 48 has flat drive faces (not shown in FIGS. 10 and 11) while the fifth drive wheel 202 has drive faces (also not shown) of the “Pelton wheel” type as referred to above.

The drive wheels are shown connected to DC generators 204.

The provision of three annular arrangements of drive faces for each of the drive wheels in this embodiment means that the relationship between torque applied to the wheels and maintaining a higher rotational speed can be changed for each of the drive wheels, as described above in relation to the embodiment of FIG. 9 in which this relationship could be changed only for the primary drive wheel 44. In the embodiment of FIGS. 10 and 11, shut-for off valves (not shown) corresponding to the shut-off valves 112, 114 and 116 of FIG. 9, are provided for determining whether the water flow is directed via the pipe 50 or the branches 108 or 110.

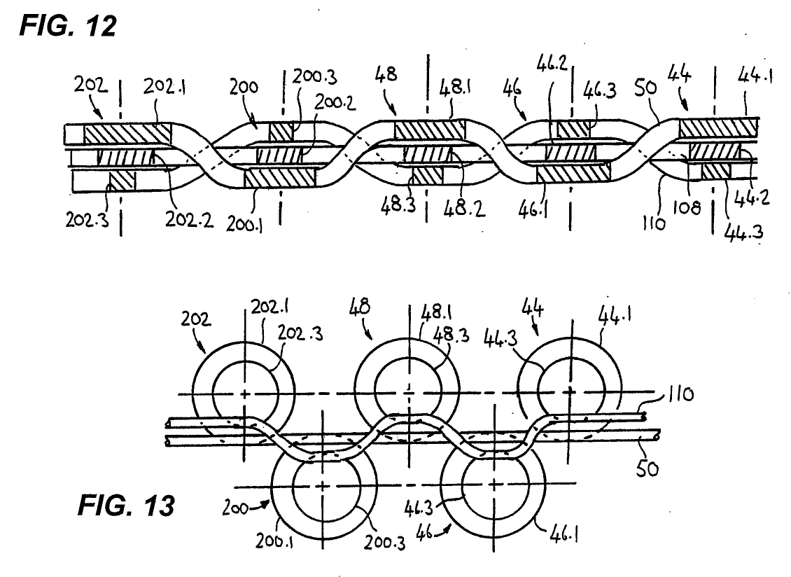

Referring to FIG. 12, there is shown another embodiment to that shown in FIGS. 10 and 11, of an arrangement of drive wheels and water pipe. Corresponding components have corresponding reference numerals.

This embodiment is similar to that of FIGS. 10 and 11 except that the orientation of the secondary and fourth drive wheels 46 and 200, respectively, in respect of the positions of their largest and smallest diameter annular arrangements, is reversed as shown.

This arrangement facilitates placing adjacent drive wheels closer together, and hence for more compactness. This is because it allows for some degree of juxtaposition between the largest and smallest diameter annular arrangements of drive faces of one drive wheel with the smallest and largest diameter annular arrangements, respectively, of each adjacent drive wheel.

However, it will be noted that, in order for the water pipe 50 and pipe branch 110 to intersect with the largest and smallest diameter annular arrangements of drive faces, respectively, of each of the drive wheels, these pipes must be of the weaving configurations as shown. However, as the second largest annular arrangements of drive faces of the drive wheels are arranged in a straight line, the pipe branch 108 need not weave and indeed is substantially straight.

In relation to the embodiment of FIG. 12, if the drive wheels were arranged in a circular configuration as opposed to the linear arrangement as shown, this embodiment could constitute an alternative to the embodiment of FIG. 4.

Referring to FIG. 13, there is shown yet another embodiment of an arrangement of drive wheels and water pipe. Corresponding components have corresponding reference numerals to those of FIGS. 10 to 12.

In this embodiment, instead of the drive wheels being arranged in a straight line as in the embodiments of FIGS. 10 to 12, the secondary and fourth drive wheels 46 and 200, respectively, are positioned at a level below the level of the primary, third, and fifth drive wheel 44, 48 and 202.

Although this arrangement is less compact than that of FIGS. 10 to 12 in the vertical direction as seen in FIG. 13, it allows for greater compactness in the axial direction of the water pipe 50 as there can be a degree of overlapping between the higher drive wheels as shown and the lower drive wheels.

In this embodiment, each of the drive wheels has only two annular arrangements of drive faces. Due to the vertical positioning of the respective drive wheels as shown, in order to properly intersect the smaller arrangements of drive faces, the pipe branch 110 is of a vertically weaving configuration as shown. However, the configuration allows for the water pipe 50 to be straight.

Instead of the engine 12 being used to propel a motor vehicle 14, it may be used for other purposes instead such as for propelling a ship or aircraft, such as a fixed wing aircraft or even a helicopter. When used for propelling a ship, it can be used to drive the ship's propeller, or other type of propulsion system that the ship may be equipped with. When used for powering an aircraft, it may be used to drive the aeroplanes propellers or rotors of a helicopter.

Alternatively, the engine 12 may be used, not for a mode of transport, but for a static use. For example there may be two engines 12 that operate in conjunction, with the drive wheel/water pipe arrangements being orientated so that the axis of the shaft 30 on which the primary drive wheel 44 is mounted is in a vertical position. The two engines in this embodiment may be orientated so as to operate in opposite rotational directions, so as to achieve a balancing of the load.

In this embodiment, and other embodiments or scenarios where two engines are used (including for modes of transport), if a single primary drive wheel and shaft is shared by the two engines, then it is important to provide for some variation in the speed of the engines, otherwise this variation may cause the engines to exert competing forces on the shaft which could in turn result in undesirable stresses of the shaft. This is, however, provided for by the fact that the “link” between each engine and the shaft is not in the form of a fixed mechanical connection, but is via the engagement of the water travelling along the water pipe 50 and the primary drive wheel. This should provide sufficient “flexibility” to accommodate variations in speeds of the two engines.

1. An internal combustion engine including:
at least one combustion chamber having a power element configured for being driven by combustion that occurs in the chamber;
a crankshaft configured for being rotated by said driving of the power element;
a water pump connected to the crankshaft and configured for pumping water via a pump outlet on rotation of the crankshaft; and
at least one drive water wheel having a series of circumferentially spaced drive faces, the drive waterwheel being disposed in relation to said pump outlet such that water pumped from said outlet will engage said drive faces for driving said drive water wheel in rotation.

2. An engine according to claim 1 wherein the combustion chamber is a cylinder, and the power element is a piston configured for reciprocating motion in the cylinder, the piston being connected to the crankshaft whereby the crankshaft is caused to rotate by said reciprocating motion.

3. An engine according to claim 1 or claim 2 wherein the drive water wheel is mounted for rotation on a propulsion shaft the rotation of which constitutes a propulsion output of the engine.

4. An engine according to any one of claims 1 to 3, configured for said combustion to be fuelled by hydrogen.

5. An engine according to claim 4, including at least one ancillary water wheel connected to a generator for generating electric current on rotation of the ancillary water wheel.

6. An engine according to claim 5 wherein the current is direct current (DC).

7. An engine according to claim 5 or claim 6, including an electrolysis device in electrical connection with said generator and configured to be actuated by said current to effect electrolysis of water to form hydrogen and oxygen.

8. An engine according to claim 7, including at least one passageway configured to direct said formed hydrogen to said combustion chamber to serve as combustion fuel therein.

9. An engine according to claim 8, including at least one passageway configured to direct said formed oxygen to said combustion chamber to facilitate combustion of said hydrogen.

10. An engine according to any one of claims 5 to 9, including a main water passageway for directing water pumped from said pump outlet into engagement with the drive faces of said at least one drive water wheel.

11. An engine according to claim 10, wherein the at least one drive water wheel is positioned in relation to said main water passageway such that part of the drive water wheel protrudes into the main water passageway so that the drive faces of said wheel that are disposed on said part of the drive water wheel are positioned so as to be engaged by water travelling along the main water passageway.

12. An engine according to claim 10 or claim 11, wherein the at least one ancillary water wheel is positioned in relation to said main water passageway such that part of the drive water wheel protrudes into the main water passageway so that the drive faces of said wheel that are disposed on said part of the drive water wheel are positioned so as to be engaged by water travelling along the main water passageway.

13. An engine according to any one of claims 10 to 12 wherein said at least one drive water wheel has an axis of rotation and includes a first set of drive faces and at least one further set of drive faces, the drive faces of each set being disposed at a different radial distance from said axis of rotation to the drive faces of each other set, the engine being configured to selectively direct said pumped water to engage with the drive faces of any one of said sets, so as to achieve variable torque exerted on said drive wheel about said axis of rotation by said pumped water depending on the which of the sets of drive faces is engaged.

14. An engine according to claim 13, including a plurality of sub-passageways each in fluid-flow communication with said main water passageway, for selectively directing the water into engagement with the drive faces of the different respective sets of drive faces of the at least one drive water wheel.

15. An engine according to claim 14, wherein each sub-passageway is provided with a shut-off valve for preventing water from entering the sub-passageway from the main water passageway.

16. An engine according to any one of the preceding claims including a plurality of said drive water wheels.

17. An engine according to any one of the preceding claims including a plurality of said ancillary water wheels.

18. An engine according to claim 16 or claim 17 wherein said water wheels are arranged in a staggered formation in relation to one another.

19. An engine according to claim 16 or claim 17 including a plurality of water wheels arranged in a substantially circular formation around a central drive water wheel.

20. An engine according to any one of the preceding claims, including a plurality of said combustion chambers.

21. A vehicle including an engine according to any of the preceding claims, the vehicle being at least one of: a motor-vehicle; a water-going vehicle; and an aircraft.
